(19) United States
(12) Patent Application Publication
(10) Pub. No.: US 2010/0009237 A1
(43) Pub. Date: Jan. 14, 2010

(54) FUEL CELL MODULE AND ITS USE

(75) Inventors: Andreas Wolff, Boffzen (DE); Morco Transitz, Heiligenstadt (DE); Thomas Jungmann, Dresden (DE); Michael Oszcipok, Freiburg (DE)

Correspondence Address: FAEGRE & BENSON LLP;PATENT DOCKETING - INTELLECTUAL PROPERTY, 2200 WELLS FARGO CENTER, 90 SOUTH SEVENTH STREET, MINNEAPOLIS, MN, 55402-3901, US

(73) Assignee: Fraunhofer-Gesellschaft Zur Forderung der, Munchen (DE)

(21) Appl. No.: 12/445,894

(22) PCT Filed: Sep. 19, 2007
(86) PCT No.: PCT/EP2007/008152

§ 371 Date: Apr. 30, 2009

(30) Foreign Application Priority Data
Oct. 16, 2006 (DE) 10 2006 048 860.1

(51) Int. Cl. H01M 8/02

(52) U.S. Cl. 429/34

(57) ABSTRACT

A planar fuel cell module including a module base unit having a plurality of recesses each adapted to receive a fuel cell therein is described. The recesses can disposed in a linear or two-dimensional planar arrangement. The module base unit also includes a strip conductor for providing electrical connection to the fuel cells. A fuel cell including an anode structure and a cathode structure is received in each of the recesses of the modular base unit. The fuel cells are disposed in each of the recesses such that the fuel cells form fit to a contour of each of the recesses. In some embodiments the anode structure and the cathode structure can be disposed offset at an angle relative to one another and can be accessible from the same side of the fuel cell. A very thin overall arrangement of a fuel cell is provided.

### CROSS-REFERENCE TO RELATED APPLICATIONS

The present application is national phase application of PCT application PCT/EP2007/008152 filed pursuant to 35 U.S.C. § 371, which claims priority to DE 102006048850.1, filed Oct. 16, 2006, both of which are herein incorporated by reference in their entirety.

### FIELD OF THE INVENTION

The present invention relates to a fuel cell module for fuel cells including a module base unit having a plurality of recesses arranged in a planar manner on which strip conductors for the electrical connection of the fuel cells are disposed. In addition, the module base unit includes a structure for distributing the fuel. Fuel cells are introduced into the recesses.

### BACKGROUND

Planar fuel cells are fuel cells which are connected in one plane. This is in contrast to the conventional stacked configuration. These relatively thin fuel cells offer the advantage that they can often be integrated in applications better than fuel cells which are constructed for example in a stack. For example, planar fuel cells can serve as part of the housing of an application such as that shown and described in DE10217034, filed on Apr. 11, 2002, entitled “Fuel Cell System in the Form of a Printed Circuit Board.” In addition, they enable a self-breathing air supply, i.e. pump-free production of air, on the cathode-side.

Planar fuel cells have the following general construction: a fuel cell side (anode), normally having the fuel-conducting structure (flow field); a gas diffusion layer (GDL) for further distribution of the fuel below the webs and for electrical connection to the catalyst; a membrane-electrode unit (MEA), possibly segmented (DE 102 24 452.9); a further GDL; and an air/oxygen side (cathode) generally with an open, self-breathing structure.

All the structures of the individual fuel cells are integrated into so-called modules which define the electrical and fluidic connection of the individual cells. For each application, one or more independent, individual modules including both an anode and a cathode must therefore be produced or adapted.

In addition, in order to avoid a protonic short circuit in a planar fuel cell, which is important during operation with methanol (MeOH), the MEA must be physically separated from every individual cell provided in a circuit. Furthermore, every MEA is required to be sealed externally in order to avoid the loss of fuel from the anode side.

### SUMMARY

According to one embodiment of the present invention, a planar fuel cell module for fuel cells is provided, including a module base unit having at least two recesses, disposed in a planar manner into which respectively one fuel cell is introduced in a form fit with respect to the contour of the recesses. Additionally, the module base unit includes at least one strip conductor for the electrical connection of the fuel cells, and also at least one fluid distribution structure for distributing the fuel.

In one embodiment, the recesses have a depth of 1 mm to 10 mm. In another embodiment, the recess have a depth of preferably 2 mm to 4 mm. In still another embodiment the recesses have a depth corresponding to the thickness of the fuel cell. Hence, an extremely flat construction of the fuel cell module is possible.

The maximum diameter of the recesses is not subject to any restriction. In one embodiment, the maximum diameter of the recesses is 1 cm to 10 cm. In another embodiment, the maximum diameter of the recesses is 1 cm to 6 cm. The maximum diameter of the recess is defined as the place in which the diameter of the recess is the greatest. For example, for a square recess this would be the diagonal.

The recesses can have any shape. The recesses can be, independently of each other, round and/or n-polygonal where, in one embodiment, 3≦n≦100 and, in other embodiments, n=3, 4, 6, or 8. It is generally understood that round refers to any geometric shape which has no corners, such as circular or oval shapes. The n-polygons can be regular or irregular. Regular shapes such as, for example, a square or a regular hexagon are preferred since these shapes can be positioned in sequence in an extremely space-saving manner.

In some embodiments, the base, which defines the recesses, does not abut directly against the anode structure of the respective fuel cell. This is advantageous during a passive operation of the fuel cell in which a great deal of fuel can pass to the anode structure. Additionally, this is advantageous where the diffusion paths of the fuel are as short as possible. Likewise, a further flattening of the module is consequently achieved since the fuel cell need not have its own fluid distribution structure. If the fuel cell is applied directly on a tank and supplied passively via convection/diffusion, the base unit can also be configured in such a manner that the base has at least one recess or is open so that the fuel can reach the anode without hindrance and without being required to follow a path such as, for example, via a flow field.

In an alternative embodiment, the base which defines the recesses has at least one mechanical device for supporting the anode. A base including a mechanical support device can support an anode structure that may be weaker and/or thinner than the cathode. Additionally, a contact pressure can be used to support the anode, which can result in reducing the construction height and materials. The mechanical device can also be structured such that it makes possible a specific distribution of the fuel, i.e. a flow field is obtained. Hence, the application of a flow structure on each individual anode of the fuel cell can be eliminated, which enables a simpler construction of the fuel cells. In one embodiment the mechanical devices have a height of 50 μm to 30 mm. In another embodiment, the mechanical devices have a height of 0.1 mm to 3 mm. In still another embodiment, the mechanical devices have a height of 0.2 mm to 1.5 mm. This embodiment is preferred if the fuel cells are not operated passively, but in a flow field. In embodiments in which the fuel cell itself has a flow structure on the anode side, the height of the mechanical device is less than 50 μm and, in some embodiments, can be substantially 0 μm.

In some embodiments, the mechanical device can have a foot shape or a parallel and/or a serial rib shape. The anode is supported at the point where the structure of the cathode likewise has such a structure so that the GDLs on both sides are pressed against each other at the same time. In an alternative embodiment, no mechanical support of the anode structure is provided.

The recesses in which the fuel cells are introduced are configured such that they can be supplied both actively and/or passively with fuel. By active supply it is meant that the fuel is conducted, for example, by means of a pump to the fuel cells. However, the possibility also exists of operating the cells completely passively in that they are incorporated, for example, on the anode side on a container filled with fuel. In this case, the supply of the fuel cells with fuel is effected, for example, via diffusion and/or convection processes.

In a further embodiment, the recesses of the module base unit have a one-dimensional or two-dimensional arrangement. In the one-dimensional embodiment, a linear arrangement of the recesses is facilitated, which leads to a linear arrangement of the fuel cells. In the case of the two-dimensional embodiment, the recesses are applied in a planar manner. In both cases, an extremely thin total arrangement of the fuel cells can be achieved, and the stack construction known from the state of the art is avoided.

In still further embodiments, the fuel cells are fitted in a form fit in the recesses in a space-saving configuration.

In several embodiments, a construction of the fuel cells for the fuel cell module provides that at least the following components are present: an anode structure, a first gas diffusion layer (GDL) which abuts the anode structure; a membrane-electrode unit (MEA) which abuts the GDL and which in some embodiments can be segmented such that it includes a catalyst layer, a membrane which abuts the catalyst layer and a subsequent further catalyst layer; a further gas diffusion layer (GDL) which abuts the MEA and also a cathode structure which abuts the further gas diffusion layer.

A construction of a fuel cell of this type makes possible the use of a large number of fuels. In various embodiments, the fuel cells can be operated preferably with hydrogen or methanol. Since the module is constructed such that the cathode side is situated on the open side, the module according to the invention is predestined for use in air. However, other oxidants such as, for example, pure oxygen are conceived if the module is operated in such an atmosphere.

The fuel cells themselves are constructed as planar modules. The anode can be provided with an open structure identical to the cathode but also with a flow field. A depression for the GDL is provided both in the anode and in the cathode half such that the GDL can be fixed locally and compressed. In the central region of the cell edge, a depression for the MEA is provided in the anode such that the depression can be fixed and sealed on the anode side. The depression serves, with a raised portion on the cathode, as a match so that the membrane-electrode unit MEA is tightly compressed/glued and so that the cell can be assembled simply and precisely. The outer region of the cell is used for gluing/welding the two frame halves.

According to various embodiments, the fuel cells have the same geometric shape as the recesses so that a match is possible. Advantageously, the fuel cells are, independently of each other, round and/or n-polygonal wherein, in one embodiment, 3≦n≦100 and, in other embodiments, n=3, 4, 6, or 8. The same applies for the geometrical shapes as discussed above in reference to the recesses.

According to various embodiments, the anode and cathode structure of the fuel cells have a frame which includes an electrically conductive structure. This structure can be configured as a honeycomb and/or grating shape. Round structures and/or oblong holes are also suitable. The material of this structure can be continuous and can be, for example, made of metal and/or of conductive polymers. In one alternative embodiment, it is also possible to ensure the conductivity of a matrix material such as, for example, plastic materials forming the structure by subsequently coating the matrix material with a conductive material. For example, the matrix material may be coated with gold using any number of sputtering processes, vapour deposition and/or galvanizing processes. The electrically conductive structure receives the electron flow which originates in the case of the anode from the fuel, and is conducted via the gas diffusion layer to the electrically conductive structure. In the case of the cathode, the electron flow originates from the electrical consumer, and is conducted via the electrically conductive structure to the gas diffusion layer thus serving as an electrical connection for each individual fuel cell.

In some embodiments, the frame which spans this structure has an electrically conductive coating in one defined region such that the coating is in electrical contact with the honeycomb and/or grating-shaped structure. In the case of a round and/or oval embodiment, the defined region is restricted to a small sector of the circle or of the oval. In examples in which an n-polygonal embodiment of the fuel cell is concerned, the defined region is at least part of a side forming the n-polygon. The remaining sides of the frame likewise have an electrical coating which is, however, not in electrical contact with the electrically conductive honeycomb and/or grating-shaped structure. The electrical contacts are configured on all sides of the frame such that they are disposed both on the outer side of the electrode and on the side of the electrode which points towards the active side of the fuel cell.

In further embodiments, the fuel cell is assembled such that the cathode and anode structure of each fuel cell, are each independently disposed offset relative to each other such that the angle between the respective side of the n-polygon which has the electrically conductive coating is at angles of 360°/n, 2×360°/n, . . . to (n−1)×360°/n. When the fuel cell is assembled, the electrical contacts of the cathode structure and of the anode structure are in electrical contact with each other. Since, only one of the contacts on each side is in contact with the electrically conductive material through which the current flows, a short circuit is avoided if the cathode or anode structure is disposed offset relative to each other by the indicated angle. As such, in certain embodiments, the current can be tapped, independently from both the upper and lower side of a planar fuel cell. In certain embodiments, both the anode and the cathode of a corresponding fuel cell are accessible from merely one side. In still other embodiments, the electrical connection of the module base unit is substantially simplified since the corresponding conductor structures need to be accommodated, for example, only on the surface of the base unit, but do not require to be guided into the recesses.

In a further embodiment, the fuel cells are plugged in, clamped on and/or fixed on the module base unit. In the case of a defect in the fuel cell, this facilitates the fuel cell to be exchanged easily.

In still further embodiments, a gasket is disposed between each of the fuel cells and the module base unit. The gasket is selected from a variety of gaskets including, but not limited to flat gaskets, gasket rings and/or gaskets moulded on the fuel cell and/or module base unit by injection moulding. The cell must then be pressed onto the gasket via clamping. The electrical connection can then be ensured via a plug or a spring mechanism, such as, for example, in a battery compartment.

In another embodiment, the fuel cells are glued, welded and/or locked onto the module base unit. In this embodiment, the adhesive and/or welded connection serves as both the seal between cell and module base unit. In various examples, the electrical connection can be soldered. By locking the fuel cells in the module base unit a form-fit connection is created such that the fuel cells are fixed on the module base unit by pressing into the precisely fitting opening. This facilitates a reversible configuration such that easy removal and exchangeability of a fuel cell is provided. In addition, the electrical contact points can have a flexible or resilient configuration, and the gaskets can have a high compressibility as is the case with O-ring gaskets.

In order to increase the total energy output, voltage output and/or current output of the cell, electrical connection of the fuel cells and/or the fluidic distribution structure can be disposed in parallel and/or in series. It is generally understood that in a serial fluidic connection the fuel fluid is conducted in succession from recess to recess. In this case, the recesses are connected to each other, regardless of how this connection is effected. For example, this can be effected via a channel produced by the boring in the module base unit and/or via connections which are produced, for example, via hoses. In the case of a parallel fluidic connection, distribution of the fuel is effected before supplying the fuel so that each fuel cell is provided individually with fuel. In some embodiments, one part of the fuel cells is connected fluidically and/or electrically in parallel and another part in series.

In another embodiment according to the present invention, the at least one strip conductor is applied on the surface of the module base unit. One advantage of such an arrangement is that the strip conductors need not be guided into the recesses since both terminals of the fuel cell are accessible from one side, saving material and costs during production.

The at least one strip conductor is configured such that it is in electrical contact, respectively, with the electrically conductive coating forming the anode and/or cathode of one fuel cell. The manner in which the connection can be effected is dependent upon the purpose of use and is known to the person skilled in the art.

According to some embodiments, the module base unit, which contains the individual fuel cells, is mechanically flexible and/or rigid. Application of a flexible fuel cell module on a large number of surfaces is made possible without the shape of the surface needing to fulfil a specific requirement. In other embodiments, the fuel cell module is mechanically rigid. For example, the fuel cell module has a high mechanical rigidity to support the mechanical rigidity of the object on which the fuel cell module is applied.

With the help of the modular construction of the fuel cell module the most varied of applications can be achieved in a flexible manner with different geometric conditions without changing the production process. For example, it is possible to apply the fuel cell module on a flat surface as well as curved surfaces. Likewise, in some embodiments, the fuel cell module can be guided around a corner on one surface. The configuration of the individual fuel cell components (electrolyte, electrodes, gas distribution structures, fluid distribution structures, current taps, mechanical carrier structures) can be adapted to the electrochemical reaction process to be used. In many embodiments, the modular construction is suitable for an appropriate mass production manufacturing process.

According to various embodiments, the fuel cell module can be used for the current supply of low-energy applications. Exemplary low-energy applications include, but are not limited to telecommunications units, mobile phones, pocket PCs, GPS devices, automatic advertising surfaces, lights, toys, applications for the camping and outdoor sphere, teaching and demonstration aids, radios, TV sets, mobile computers, emergency power supplies, alarm units, mobile mains-independent charging devices, medical appliances and military applications. The cells can be incorporated in a modular fashion such that a corresponding number of fuel cells can be connected according to the necessary voltage, current or power requirements and/or according to the space which is available.

Since the cathode is already present on every cell, the cathode need no longer be manufactured separately. Additionally, since each cell is manufactured individually with a separate MEA, the problem of an ionic short circuit no longer exists, facilitating each cell to be sealed separately.

A wide variety of materials and production methods can be used to fabricate the fuel cells and the module base unit. For example, in some embodiments, printed circuit boards (PCB) or materials made by injection moulding processes can be used.

### BRIEF DESCRIPTION OF THE DRAWINGS

The facts according to the invention are explained in more detail with reference to the following Figures without restricting the invention to the special embodiments, as represented in the Figures.

FIG. 1 is a perspective view of both a cathode and an anode structure according to an embodiment of the present invention.

FIG. 2 is a side view and a plan view of a cathode and an anode structure according to an embodiment of the present invention.

FIG. 3 is a perspective view of both a cathode and an anode structure according to an embodiment of the present invention.

FIG. 4 is an exploded view of a fuel cell according to an embodiment of the present invention.

FIG. 5 is an exploded view showing certain individual structural elements of a fuel cell according to an embodiment of the present invention.

FIG. 6 is an exploded view showing certain individual structural elements of a fuel cell according to an embodiment of the present invention.

FIG. 7 is a perspective view of the fuel cell shown in FIG. 4 according to an embodiments of the present invention.

FIGS. 8a and 8b are schematic views of fuel cell module having a linear arrangement according to various embodiments of the present invention.

FIGS. 9a and 9b are schematic views of a fuel cell module having a two-dimensional arrangement according to various embodiments of the present invention.

FIG. 10 is a schematic view of a mechanical device for supporting the anode and the module base unit according to an embodiment of the present invention.

### DETAILED DESCRIPTION

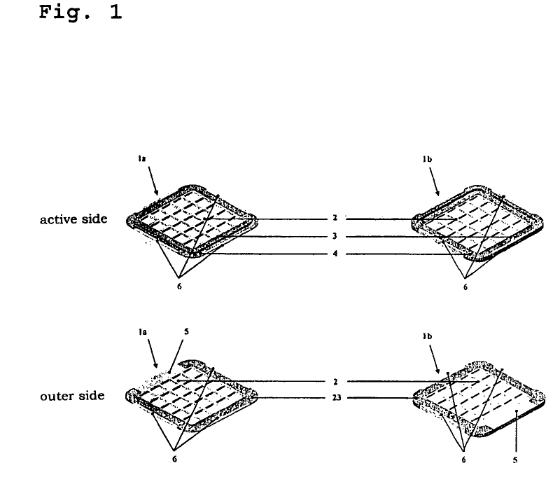

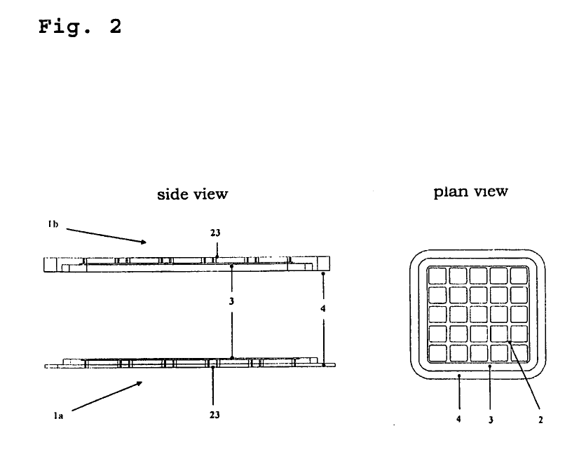

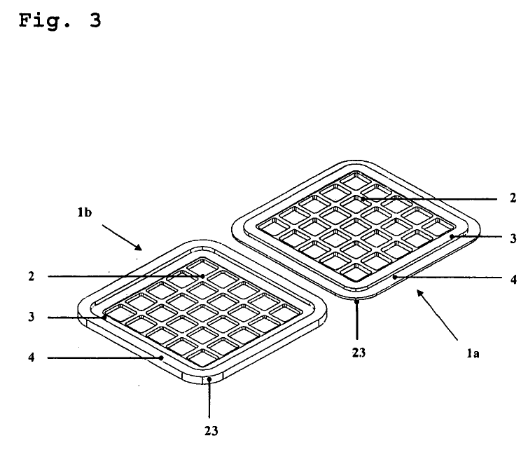

In FIGS. 1 to 3, the basic structure of the two similar cathode 1a and anode structures 1b is represented in various perspective representation forms (side view, plan view). According to one illustrative embodiment, as shown in FIGS. 1-3, the cathode and anode structures 1a and 1b have a square configuration. The frame underlying the cathode structure 1a and the anode structure 1b can be formed from any electrically non-conductive material. In one embodiment, plastic materials such as, for example, PPS can be used. In one embodiment, an electrically coated grating structure 2 is inserted in this structure. In another embodiment, this structure can also be formed entirely from an electrically conductive material. On the active sides thereof, the cathode 1a and anode structure 1b have a support surface 3 such as, for example, a sealing surface or a fitting groove for the MEA. In one embodiment, the support surface 3 on the cathode structure 1a is configured as a raised portion, and the support surface 3 on the anode structure 1b is configured as a depression. Additionally, an adhesive or weld surface 4 abuts on the periphery of the support surfaces 3, via which the assembly of the cathode structure 1a and the anode structure 1b is effected. On one side, the frame 23 has an electrical contact 5 which is in electrical connection with the structure 2. However, the other sides have electrical contacts 6 which are not in electrical connection with the structure 2. It is common to all electrical contacts 5 and 6 that they completely cover the outer side of the frame 23 and are configured, at least partially, on at least the active and outer side. In FIGS. 2 and 3, the electrical contacts are omitted for the sake of an overview so that the basic components of the cathode structure 1a or anode structure 1b are better shown.

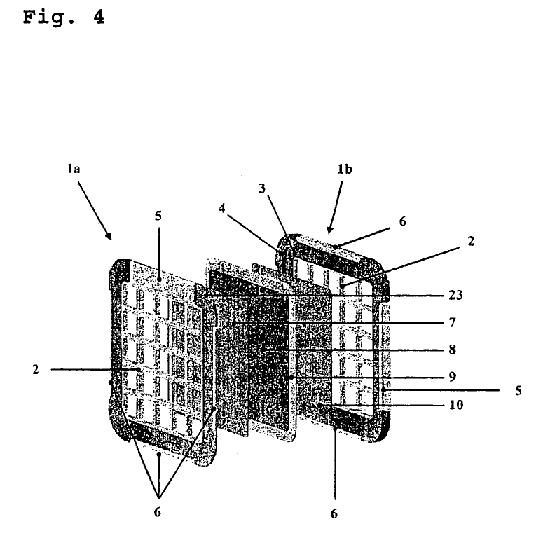

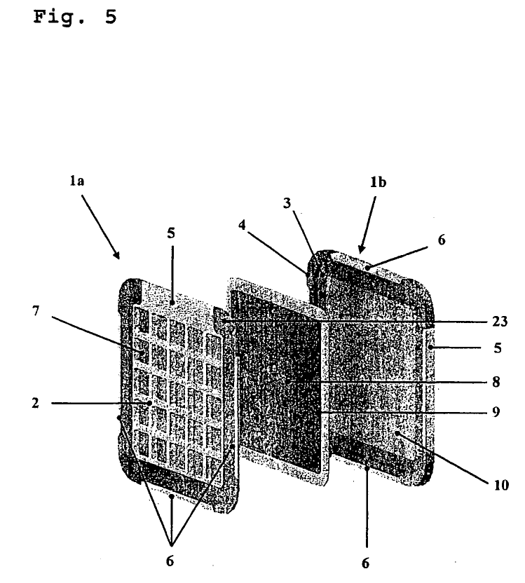

FIG. 4 represents an exploded drawing of a fuel cell 14 according to one embodiment of the present invention, the assembly of which is shown in succession in FIGS. 5, 6 and 7 until the fuel cell 14 is complete. The basic components of the fuel cell 14 according to various embodiments of the present invention are the cathode structure 1a, a first gas diffusion layer (GDL) 7, a membrane-electrode unit (MEA) 8 which is spanned by a membrane 9, a further gas diffusion layer (GDL) 10 and also the anode structure 1b. With respect to the reference numbers of the anode 1b and cathode structure 1a, reference is made to the description relating to FIGS. 1 to 3. In one embodiment, as shown, the cathode structure 1a is disposed relative to the anode structure 1b in such a manner that the two electrically conductive coatings 5 which are connected to the structures 2 are disposed at an angle of 90° relative to each other. Additionally, as shown in FIGS. 4-6 the two gas diffusion layers (GDL) 7 and 10 are inserted respectively in the cathode structure 1a and anode structure 1b. The two gas diffusion layers 7 and 10 are thereby dimensioned such that they form a seal with the net-shaped structure 2 in a form fit. If necessary, the gas diffusion layers 7 or 10 can be fixed with an adhesive. The non-illustrated grooves thereby have the optimum depth for the respective embodiment which is used.

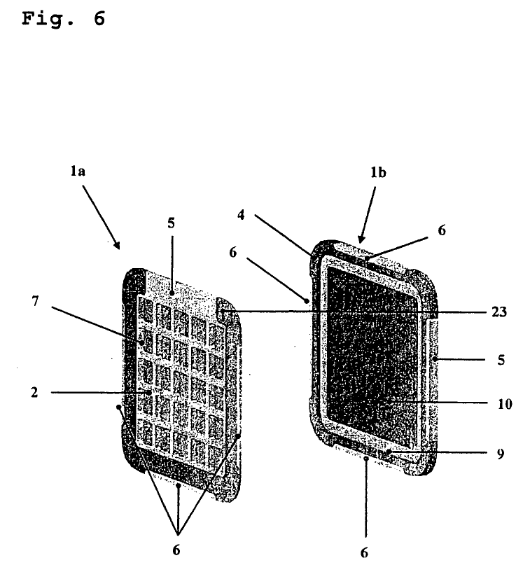

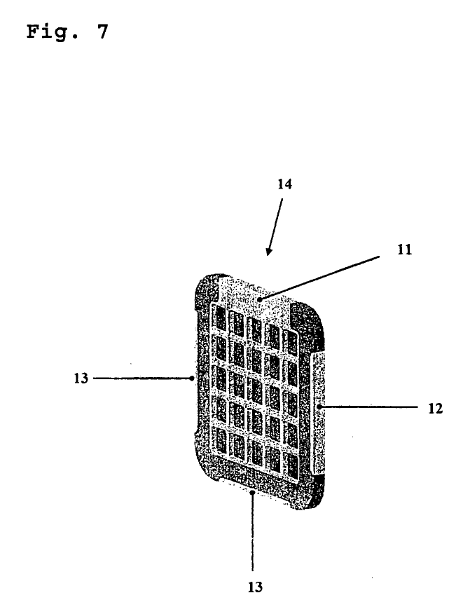

In one embodiment, as shown in FIG. 6, the catalyst layer 10 with membrane 9 is inserted in the anode structure 1b on the support surface provided for this purpose. The groove is deeper than the membrane so that, together with the opposite side (here configured as cathode structure 1a), a match is produced. The intermediate space which is produced between the halves is optimised so that a favourable contact pressure on the components is produced, causing as low a cell resistance as possible, and such that the catalyst layer 10 is compressed tightly with the anode structure 1b. If necessary, an additional groove can be provided for sealing or the membrane 9 can be glued onto the anode with an adhesive material. In the next step, the two cell halves are connected to each other so that the entire cell 14, as illustrated in FIG. 7, is produced. This can be accomplished by gluing, laser welding or ultrasonic welding the two cell halves. Since the cathode structure 1a and the anode structure 1b are disposed relative to each other at a relative angle of 90° with respect to the contacts 5, the new electrical contacts 12 (anode) and 14 (cathode), which are in connection with the respective anode or cathode-side grating-shaped structures 2, are produced during assembly. The contacts 5 are thereby in connection with the contacts 6 of the respectively opposite electrode. Hence, a continuously conductive surface is produced such that a current tap is possible from any side of the fuel cell 14. The two other contacts 13 are provided in the event that the two contacts 6, which are not in connection with the grating-shaped structure 2, are situated one upon the other. In another embodiment, the cathode structure 1a and the anode structure 1b are arranged at a relative angle of 180° or 270° relative to each other. Hence, in the case of this square embodiment as shown in FIG. 7, three possible connection possibilities of the cathode structure 1a and anode structure 1b are in fact produced.

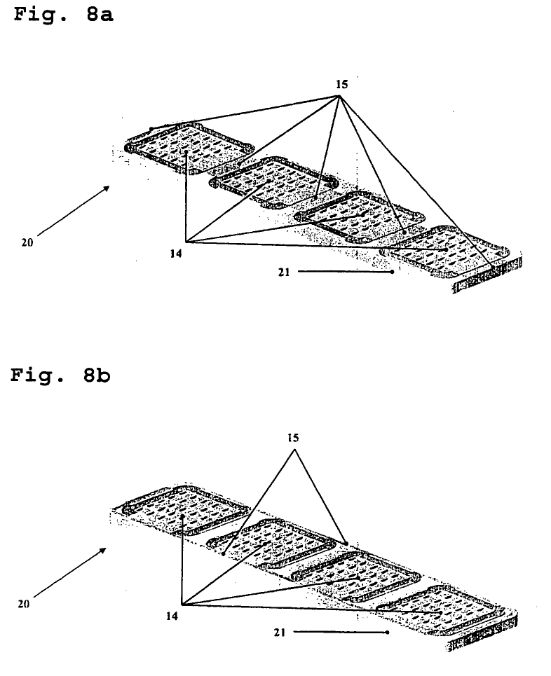

In FIGS. 8a and 8b, the linear embodiments of a fuel cell module 20 according to the invention are represented. The fuel cells 14 embodied in FIG. 7 are thereby applied linearly on a module base unit in FIG. 8a and connected electrically in series via the conduction devices 15. The fuel cells 14 are shown in FIG. 8b connected electrically in parallel via the conduction devices 15. The fuel cells both in FIG. 8a and in FIG. 8b have an assembly in which cathode structure 1a and anode structure 1b are disposed offset relative to each other by 180°. The cells 14 can be incorporated in the module base unit 21 using a variety of techniques. In one embodiment, the fuel cells 14 can be exchangeable and can be plugged-in electrically and sealed fluidically with gaskets. For example, in one embodiment, the fuel cells can be fixed or clamped via a clamping device. In another embodiment, the fuel cells 14 can be plugged-in via retaining clamps which press the cell onto a gasket. In another embodiment, the fuel cells are not removable, but rather are soldered electrically and sealed fluidically such as, for example, by adhesive faces or weld seams.

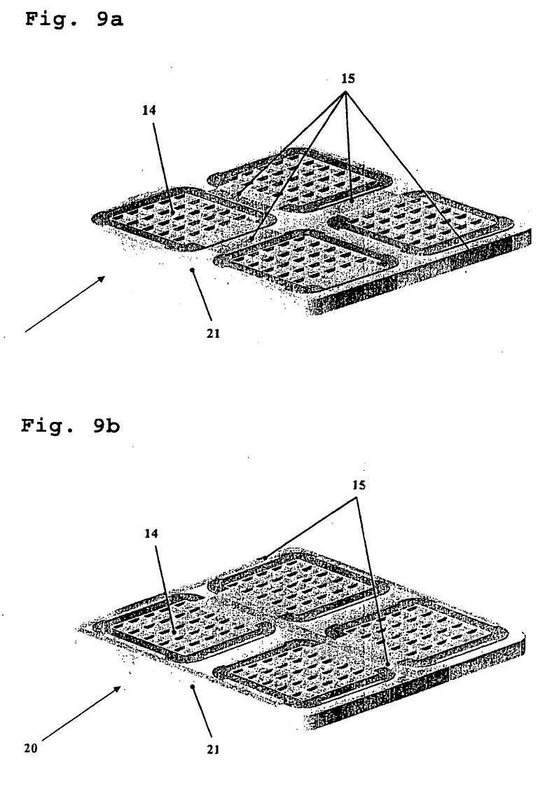

FIGS. 9a and 9b show further arrangement possibilities of fuel cells 14 in a fuel cell module 20 according to the invention. In FIGS. 9a and 9b, the fuel cells are planar and are disposed two-dimensionally on a module base unit 21 such that the electrical connection shown in FIG. 9a is effected via the conduction devices 15, and the electrical connection shown in FIG. 9b is parallel via the conduction devices 15. For possibilities of incorporation of the fuel cells 14 in the module 20, the possibilities which were mentioned also for FIGS. 8a and 8b also can apply. In addition, the possibility is also represented in FIG. 9a that an electrical connection of the fuel cells is effected at an angle of 90°. The cathode 1a and anode structure 1b can be assembled offset relative to each other by 90°.

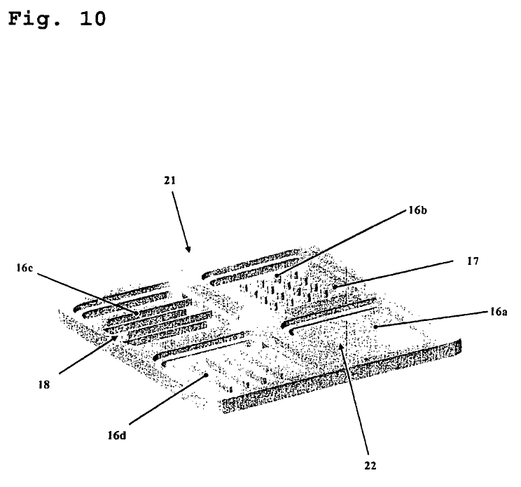

FIG. 10 shows other embodiments of the module base unit 21 which can serve for mechanical support of the anode structure 1b. In one embodiment, as shown, a mechanical support 16a with a planar configuration is provided. For example, if the fuel cell 14 is intended to be supplied passively with fuel, then the fuel cell 14 can be arranged as close as possible to the module base unit 21 such that the diffusion paths are as small as possible. The mechanical embodiments can be configured in a variety of ways, but feet (16b) or serial (16c) or parallel (16d) embodiments are preferred. In the latter two embodiments 16c and 16d, the web-like structures can also be disposed such that the fuel is conducted specifically to the anode structure so that an improved supply of the anode structure with fuel is possible by means of a flow field arranged in this manner.

The mechanical support structures can then be applied respectively on the base 17 of a surface forming a recess. Module base units 21 having the same support structure 16 are also contemplated.

1-28. (canceled)

29. A planar fuel cell module comprising:
a module base unit comprising a base defining at least two recesses disposed in a planar configuration, each recess adapted to receive a fuel cell therein, and at least one strip conductor providing electrical connection to one or more fuel cells;
a fuel cell comprising an anode structure and a cathode structure received in each of the recesses of the modular base unit, wherein the fuel cells are disposed in each of the recesses such that the fuel cells form fit to a contour of each of the recesses; and
at least one fluid distribution structure configured to distribute fuel to the fuel cells.

30. The fuel cell module according to claim 29, wherein the recesses have a depth of 1 mm to 10 mm and a maximum diameter of the recesses ranges from 1 cm to 10 cm.

31. The fuel cell module according to claim 29, wherein the recesses are each independently round or n-polygonal, wherein n=3, 4, 6, or 8.

32. The fuel cell module according to claim 29, wherein the fuel cells are each independently round and n-polygonal, wherein n=3, 4, 6, or 8.

33. The fuel cell module according to claim 32, wherein the fuel cells are electrically connected to each other at angles between 360°/n and (n−1)·360°/n.

34. The fuel cell module according to claim 29, wherein the base does not abut against the anode structure of the fuel cell.

35. The fuel cell module according to claim 29, further comprising at least one mechanical support disposed on the base and adapted to support the anode structure of at least one fuel cell, wherein a height of the mechanical support is 0.05 mm to 30 mm.

36. The fuel cell module according to claim 35, wherein the mechanical support has a foot shape, a parallel rib shape, or a serial rib shape.

37. The fuel cell module according to claim 29, wherein the recesses have a linear or a two-dimensional arrangement.

38. The fuel cell module according to claim 29, further comprising a gasket disposed between each fuel cell and module base unit.

39. The fuel cell module according to claim 29, wherein the anode structure and the cathode structure of each of the fuel cells comprise a frame including an electrically conductive structure comprising an electrically conductive coating on at least one defined region of the frame, wherein the electrically conductive coating is in electrical contact with the electrically conductive structure.

40. The fuel cell module according to claim 39, wherein the at least one defined region comprises one side of the frame, wherein the frame defines an n-polygon in which n=3, 4, 6, or 8, and wherein each of the remaining sides of the frame have an electrically conductive coating that is not in electrical contact with the electrically conductive structure of the frame.

41. The fuel cell module according to claim 40 wherein the anode structure and the cathode structure of each fuel cell are disposed offset relative to each other such that an angle between the side of the frame comprising the one defined region including the electrically conductive coating is at angles of between 360°/n and (n−1)×360°/n.

42. The fuel cell module according to claim 29, wherein at least one fuel cell comprises an electrically conductive coating forming the anode and/or the cathode and wherein the at least one strip conductor is in electrical contact with the electrically conductive coating of the at least one fuel cell.

43. The fuel cell according to claim 29, wherein the module base unit is flexible.

44. A planar fuel cell module comprising:
a module base unit comprising a base defining at least two recesses disposed in a planar configuration, each recess adapted to receive a fuel cell therein;
at least one strip conductor for providing electrical connection to one or more fuel cells disposed on the module base unit; and
a fuel cell removably received in each of the recesses of the modular base unit, wherein a shape of the fuel cell corresponds to a shape of the recess in which it is received, each fuel cell comprising an anode structure and a cathode structure, the anode and cathode structures offset at an angle relative to one another.

45. The planar fuel cell module according to claim 44, wherein the anode and cathode structures are offset at a 90° angle relative to an another.

46. The planar fuel cell module according to claim 44, wherein the anode and cathode structures are offset at an 180° angle relative to one another.

46. The planar fuel cell module according to claim 44, wherein the anode and the cathode structures are accessible from a single side of the fuel cell.

47. A low energy electrical device comprising:
a planar fuel cell module comprising a module base unit comprising a base defining at least two recesses disposed in a planar configuration, each recess adapted to receive a fuel cell therein; at least one strip conductor for providing electrical connection to one or more fuel cells disposed on the module base unit; a fuel cell removably received in each of the recesses of the modular base unit, wherein a shape of the fuel cell corresponds to a shape of the recess in which it is received, each fuel cell comprising an anode structure and a cathode structure, the anode and cathode structures offset an angle relative to one another; and at least one fluid distribution structure configured to distribute fuel to the fuel cells.
